(19) United States
(12) Patent Application Publication
(10) Pub. No.: US 2019/0007153 A1
(43) Pub. Date: Jan. 3, 2019

(54) SYSTEMS AND METHODS FOR CONCURRENT TRANSMISSION

(71) Applicant: QUALCOMM Incorporated, San Diego, CA (US)

(72) Inventors: Joel Linsky, San Diego, CA (US); Anssi Haverinen, San Diego, CA (US); Le Luong, San Diego, CA (US); Yoshiro Fukuoka, Solana Beach, CA (US); Paul DenBoer, Escondido, CA (US); Huibert DenBoer, Escondido, CA (US)

(21) Appl. No.: 15/637,782

(22) Filed: Jun. 29, 2017

(51) Int. Cl. H04J 3/16; H04W 72/12; H04L 12/801; H04W 72/08; H04W 16/14; H04L 12/54

(52) U.S. Cl. CPC H04J 3/1682; H04W 72/1205; H04L 12/56; H04W 72/08; H04W 16/14; H04L 47/10

(57) ABSTRACT

A wireless communication device for concurrent transmission is described. The wireless communication device includes a first transmitter that sends a first transmit packet on a first frequency. The wireless communication device also includes a second transmitter that sends a second transmit packet on a second frequency that overlaps in time with the first transmit packet. The wireless communication device further includes a processor that coordinates when the first and second transmit packets end such that a first receive packet does not overlap in time with a second receive packet or the second transmit packet. The wireless communication device additionally includes a demodulator that demodulates both the first receive packet in response to the first transmit packet and the second receive packet in response to the second transmit packet.

### TECHNICAL FIELD

The present disclosure relates generally to wireless communications. More specifically, the present disclosure relates to systems and methods for concurrent transmission by a wireless communication device.

### BACKGROUND

In the last several decades, the use of wireless communication devices has become common. In particular, advances in electronic technology have reduced the cost of increasingly complex and useful wireless communication devices. Cost reduction and consumer demand have proliferated the use of wireless communication devices such that they are practically ubiquitous in modern society. As the use of wireless communication devices has expanded, so has the demand for new and improved features of wireless communication devices. More specifically, wireless communication devices that perform new functions and/or that perform functions faster, more efficiently or more reliably are often sought after.

Advances in technology have resulted in smaller and more powerful wireless communication devices. For example, there currently exists a variety of wireless communication devices such as portable wireless telephones (e.g., smartphones), personal digital assistants (PDAs), laptop computers, tablet computers and paging devices that are each small, lightweight and can be easily carried by users.

A wireless communication device may make use of one or more wireless communication technologies. For example, a wireless communication device may communicate using Bluetooth technology. A wireless communication device may send and receive audio or other data to other remote devices. For example, a handset may send an audio stream to one or more headsets.

In many cases, it may be beneficial to perform concurrent transmission. For example a wireless communication device may send multiple signals at the same time by using multiple transmitters. While transmitters (e.g., modulators) may be relatively small, demodulators may require a larger area and may add costs to the wireless communication device. Therefore, it is beneficial to reuse a single demodulator with multiple transmit chains in a wireless communication device.

### SUMMARY

A wireless communication device for concurrent transmission is described. The wireless communication device includes a first transmitter that sends a first transmit packet on a first frequency. The wireless communication device also includes a second transmitter that sends a second transmit packet on a second frequency that overlaps in time with the first transmit packet. The wireless communication device further includes a processor that coordinates when the first and second transmit packets end such that a first receive packet does not overlap in time with a second receive packet or the second transmit packet. The wireless communication device additionally includes a demodulator that demodulates both the first receive packet in response to the first transmit packet and the second receive packet in response to the second transmit packet.

The processor may apply a delay to the second transmit packet to ensure that the first receive packet and the second receive packet do not overlap in time. The delay may be based on a size of the first receive packet and an inter-frame spacing. The inter-frame spacing between the first transmit packet and the first receive packet may be equivalent to the inter-frame spacing between the second transmit packet and the second receive packet.

The first and second transmit packets may be transmitted simultaneously. The second receive packet may be delayed to ensure that it does not overlap with the first receive packet.

The first receive packet may be received on the first frequency and the second receive packet may be received on the second frequency. Alternatively, both the first receive packet and the second receive packet may be received on the same frequency.

The first transmit packet may include a left channel encoded audio stream. The second transmit packet may include a right channel encoded audio stream.

The first response packet may include an acknowledge (ACK) or non-acknowledge (NACK) response packet corresponding to the first transmit packet. The second response packet may include an ACK or NACK response packet corresponding to the second transmit packet.

If a NACK response packet is received, the processor may coordinate a retransmission of a corresponding transmit packet using both the first transmitter and the second transmitter. The processor may use the NACK response packet to estimate channel state information. The processor may determine beam forming for the first transmitter and the second transmitter based on the channel state information.

A method for concurrent transmission is also described. The method includes sending, by a first transmitter, a first transmit packet on a first frequency. The method also includes sending, by a second transmitter, a second transmit packet on a second frequency that overlaps in time with the first transmit packet. The method further includes coordinating, by a processor, when the first and second transmit packets end such that a first receive packet does not overlap in time with a second receive packet or the second transmit packet. The method additionally includes demodulating, by a demodulator, both the first receive packet in response to the first transmit packet and the second receive packet in response to the second transmit packet.

A non-transitory tangible computer readable medium for concurrent transmission is also described. The computer readable medium may store computer executable code for causing a wireless communication device to send, by a first transmitter, a first transmit packet on a first frequency. The computer readable medium may also include code for causing the wireless communication device to send, by a second transmitter, a second transmit packet on a second frequency that overlaps in time with the first transmit packet. The computer readable medium may further include code for causing the wireless communication device to coordinate, by a processor, when the first and second transmit packets end such that a first receive packet does not overlap in time with a second receive packet or the second transmit packet. The computer readable medium may additionally include code for causing the wireless communication device to demodulate, by a demodulator, both the first receive packet in response to the first transmit packet and the second receive packet in response to the second transmit packet.

An apparatus for concurrent transmission is also described. The apparatus includes means for sending a first transmit packet on a first frequency. The apparatus also includes means for sending a second transmit packet on a second frequency that overlaps in time with the first transmit packet. The apparatus further includes means for coordinating when the first and second transmit packets end such that a first receive packet does not overlap in time with a second receive packet or the second transmit packet. The apparatus additionally includes means for demodulating both the first receive packet in response to the first transmit packet and the second receive packet in response to the second transmit packet.

### BRIEF DESCRIPTION OF THE DRAWINGS

FIG. 1 is a block diagram illustrating one configuration of a wireless communication system in which concurrent transmission by a wireless communication device may be implemented;

FIG. 2 is a flow diagram illustrating a configuration of a method for concurrent transmission by a wireless communication device;

FIG. 3 is a timing diagram illustrating an approach for concurrent transmission by a wireless communication device;

FIG. 4 is a timing diagram illustrating an approach for concurrent transmission of stereo audio by a wireless communication device;

FIG. 5 is a timing diagram illustrating another approach for concurrent transmission by a wireless communication device;

FIG. 6 is a flow diagram illustrating a configuration of a method for dynamic transmit diversity by a wireless communication device; and

FIG. 7 illustrates certain components that may be included within a wireless communication device.

### DETAILED DESCRIPTION

A wireless communication device may be configured to communicate with multiple remote devices. For example, the wireless communication device may be a handset that is configured to communicate with remote speakers (e.g., headsets) using a wireless communication protocol. In an implementation, the wireless communication protocol may be Bluetooth low energy (BLE).

It is beneficial to make air traffic efficient while minimizing hardware design when a wireless communication device is communicating with one or more remote devices (e.g., Bluetooth headset(s)). In many implementations, a modulator in a transmitter is relatively small (in terms of silicon area) whereas the demodulator in a receiver may require a larger silicon area. In a system with two radio chains (for receive and transmit), full concurrent (e.g., simultaneous) operation of two radio paths can be costly. In some scenarios, similar data is sent to multiple receivers (for example, a left and right ear bud) at a similar rate.

Systems that can reduce the complexity of the silicon through protocol timing can have a cost advantage compared to those that cannot. Therefore, it would be beneficial to reuse a single demodulator with multiple transmit chains in a wireless communication device (e.g., that communicates with a wireless headset).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

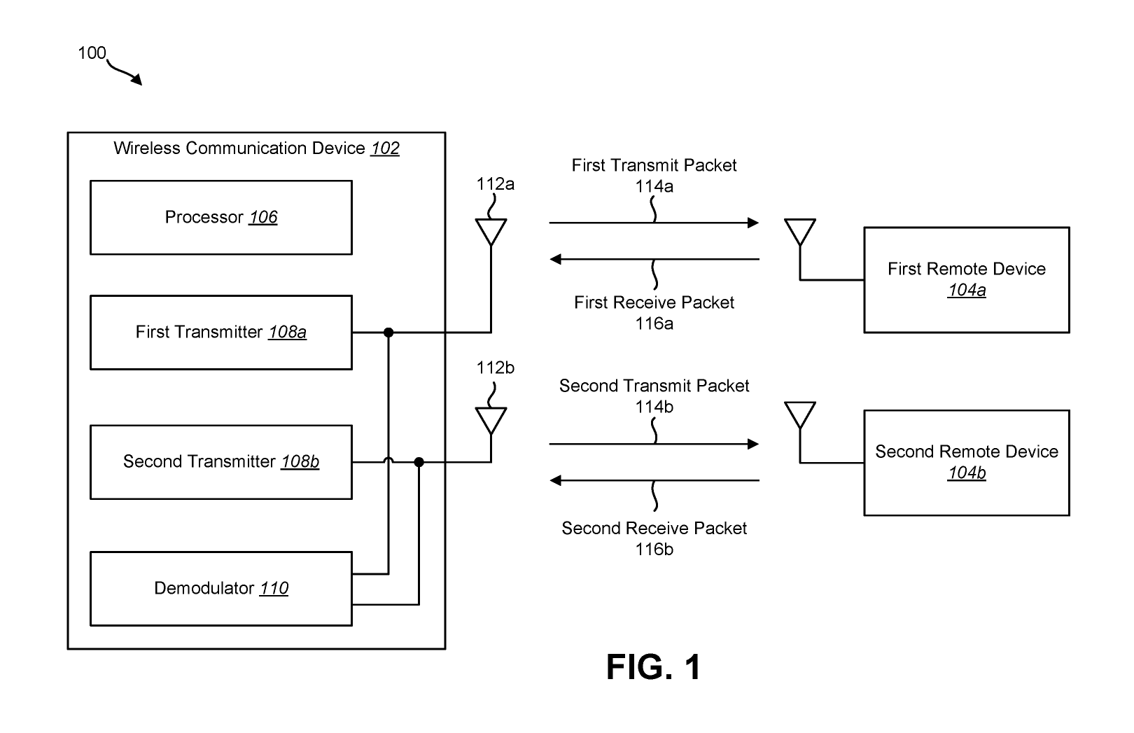

FIG. 1 is a block diagram illustrating one configuration of a wireless communication system 100 in which concurrent transmission by a wireless communication device 102 may be implemented. The wireless system 100 may include the wireless communication device 102 and a plurality (e.g., two or more) remote communication devices 104. Wireless communication systems 100 are widely deployed to provide various types of communication content such as voice, data, audio, and so on.

Some wireless communication devices 102 may utilize multiple communication technologies. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), Institute of Electrical and Electronics Engineers (IEEE) 802.11 (Wi-Fi) networks, Bluetooth (BT) networks, wireless Universal Serial Bus (USB) networks, etc.).

Communications in a wireless communication system 100 (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas 112 are utilized.

The wireless communication device 102 is an electrical device that may be configured to communicate using Bluetooth protocols. A wireless communication device 102 may also be referred to as a wireless device, a mobile device, mobile station, subscriber station, client, client station, user equipment (UE), remote station, access terminal, mobile terminal, terminal, user terminal, subscriber unit, etc. Examples of wireless communication devices 102 include laptop or desktop computers, cellular phones, smartphones, wireless modems, e-readers, tablet devices, gaming systems, keyboards, keypads, computer mice, remote controllers, handsets, headsets, headphones, automobile hands-free audio system, etc.

A wireless communication device 102 configured to communicate using Bluetooth may be referred to as a Bluetooth device. A Bluetooth device may be configured to establish links with one or more target devices that have Bluetooth transceivers. Bluetooth is a packet-based protocol with a master-slave structure. Bluetooth operates in the Industrial, Scientific and Medical (ISM) 2.4 GHz short-range radio frequency band (e.g., 2400-2483.5 MHz). Bluetooth uses a radio technology called frequency-hopping spread spectrum in which transmitted data is divided into packets and each packet is transmitted on a designated Bluetooth frequency (e.g., channel).

Communications in a Bluetooth network may be achieved based on a master polled system. The master polled system may utilize time-division duplexing (TDD) in which a Bluetooth device sends a packet to a target device. For example, the wireless communication device 102 may operate as a master. The wireless communication device 102 may send a packet to a target remote device 104 during pairing, during a connection request or during subsequent communication. In one implementation, the wireless communication device 102 may be a master device. A first remote device 104a and a second remote device 104b may be slave devices. In a master polled system, the master device sending the packet gives the slave device the ability to transmit back.

The Bluetooth wireless communication standard is typically employed for exchanging communications between fixed or mobile Bluetooth-enabled devices over short distances. In some configurations, the systems and methods disclosed herein may be applied to Bluetooth Low Energy (BLE) devices. LE refers to the “Low Energy” extension of the Bluetooth standard. The BLE extension is focused on energy-constrained applications such as battery-operated devices, sensor applications, etc. The BLE extension may also be referred to as Bluetooth Smart.

The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices 102 that do not conform to Bluetooth standards.

In many scenarios, it is beneficial to perform concurrent transmission from a wireless communication device 102 to one or more remote devices 104. One scenario in which concurrent transmission is beneficial is 2×2 Bluetooth operation. On the handset side, two concurrent radio transceivers may operate independently of each other or in a scheduled dependency mode of operation. The transition from having a single radio in a handset to multiple radios in a handset presents opportunities with how packets may be scheduled to different remote devices 104.

Another scenario in which concurrent transmission may be beneficial is stereo audio for separate remote devices 104. For example, a headset may include two separate earbuds for each ear. Each earbud may be a remote device 104 that is configured to communicate with the wireless communication device 102 on a separate radio path. One earbud may receive a transmit packet 114 from the wireless communication device 102 for a left channel and the other earbud may receive another transmit packet 114 for the right channel.

In one approach to stereo audio transmission to wireless headsets or speakers using Bluetooth or Bluetooth Low Energy, one Bluetooth transceiver (i.e., transmitter and receiver) is included in a remote device 104, and a wired connection provides the audio signal between left and right speakers. However, this approach requires that the audio signal is forwarded over a wire, which may limit the distance between the speakers and/or the feasibility in connecting the speakers.

In another approach, two Bluetooth transceivers may be used in one remote device 104 to establish one wireless connection to the handset and a separate wireless connection between left and right speakers. In this approach, the audio is forwarded wirelessly to the separate speakers. However, power consumption for the forwarding device is higher than the receiving device, as it uses two wireless links at a time. Furthermore, radio channel congestion is high, because of two links. This may impact the operation of other wireless communication technologies (e.g., WiFi) that perform contention access.

In yet another approach, the audio source device may include two Bluetooth transceivers, and two wireless connections may be established between the audio source device and the speakers (e.g., remote devices 104). In one implementation, both remote devices 104 receive the same joint encoded stereo stream, and play back only left or right channel each. In another implementation, the remote devices 104 receive only the left or right channel of a non-joint encoded stereo stream (which may be referred to as “true stereo”). This approach may result in the lowest radio congestion, and lowest overall system power consumption of all the wireless approaches. However, problems still persist with this approach.

When the audio source uses a regular Bluetooth transceiver, it can transmit audio packets to one receiver at a time. When the transceiver is collocated with another 2.4 GHz technology (e.g., a wireless local area network (WLAN) (also referred to as WiFi)), it is beneficial to reduce the overall time the radio links are used as much as possible to allow more time and throughput to the other technology. To improve radio channel congestion for “true stereo” operation, the transmission time to two remote devices 104 can be shortened by transmitting two signals (e.g., the left channel and the right channel) on two different radio frequencies at the same time.

The systems and methods described herein provide for efficient air traffic while minimizing hardware design when a wireless communication device 102 (e.g., handset) is communicating with remote devices 104 (e.g., a Bluetooth headset). In many implementations, the modulator in a transmitter 108 is relatively small (in terms of silicon area) whereas a demodulator 110 in the receiver may require a larger silicon area.

In a system with two radio chains (for receive and transmit), full simultaneous operation of two radio paths can be costly. In some scenarios, similar data is sent to multiple remote devices 104 (for example, a left and right earbud) at a similar rate. Systems that can reduce the complexity of the silicon through protocol timing can have a cost advantage of those that cannot.

The systems and methods described herein provide for the reuse of a single demodulator 110 with multiple transmitters 108a-b to communicate with one or multiple remote devices 104a-b. The described system 100 is described in terms of an audio system where approximately the same amount of data is sent to multiple earbuds. This type of a system is common since the data rate and packetization of audio data would be approximately the same for both left and right channels in a wireless headset. However, it should be noted that the systems and methods described herein may be applied to other types of non-audio data communication.

The single demodulator 110 may be configured to receive packets 116a-b corresponding to both the first transmitter 108a and the second transmitter 108b. For example, the demodulator 110 may be coupled to two receive paths. One receive path may be associated with a first antenna 112a and the other receive path may be associated with a second antenna 112b.

The wireless communication device 102 may include a processor 106 that coordinates when the wireless communication device 102 transmits a first transmit packet 114a and a second transmit packet 114b. The processor 106 may schedule when the first and second transmit packets 114 end such that a first receive packet 116a does not overlap in time with a second receive packet 116b or the second transmit packet 116b.

In certain wireless communication systems (e.g., Bluetooth), the master device (e.g., handset) typically sends a transmit packet 114, then a certain amount of time later, the master device receives a receive packet 116 from the slave device. The receive packet 116 may be an acknowledge (ACK) or non-acknowledge (NACK) response packet corresponding to the transmit packet 114. In other words, the slave device may send an ACK if the transmit packet 114 is received correctly, otherwise the slave device may send a NACK. The first response packet 116a may be an ACK or NACK response packet corresponding to the first transmit packet 114a and the second response packet may be an ACK or NACK response packet corresponding to the second transmit packet 114b.

The amount of time between the end of the transmit packet 114 and the start of the receive packet 116 may be referred to as the inter-frame spacing (IFS). For example, in BLE, the IFS is specified as 150 microseconds (us). However, the IFS can be any length depending on the technology. In other words, the IFS does not have to be 150 microseconds.

The first transmitter 108a may send a first transmit packet 114a on a first frequency. For example, the first transmitter 108a may be coupled to a first antenna 112a. The second transmitter 108b may send a second transmit packet 114b on a second frequency. For example, the second transmitter 108b may be coupled to a second antenna 112b. The second transmit packet 114b may overlap in time with the first transmit packet 114a. In other words, the first transmitter 108a and the second transmitter 108b may transmit simultaneously.

The demodulator 110 may demodulate both the first receive packet 116a in response to the first transmit packet 114a and the second receive packet 116b in response to the second transmit packet 114b. As used herein, the term “demodulate” refers to the process of extracting an original information-bearing signal from a modulated carrier wave or signal. Therefore, the demodulator 110 may recover information content included in a receive packet 116 sent on a modulated carrier wave.

In an approach, the wireless communication device 102 may include multiple transmit paths and a single receive path to concurrently communicate with a headset with two channels. The wireless communication device 102 may use the two transmitters 108 to transmit two transmit packets 114 (on two different frequencies) that overlap in time. The processor 106 may apply a delay (i.e., a time shift) to the second transmit packet 114b so that the receive packets 116 (e.g., ACK/NACKs) for those two transmit packets 114 can both be received at different times using the single demodulator 110. Therefore, in this approach, the wireless communication device 102 may perform time division duplexing (TDD) on the reception side (i.e., the demodulator 110) and time-overlapping on the transmission side.

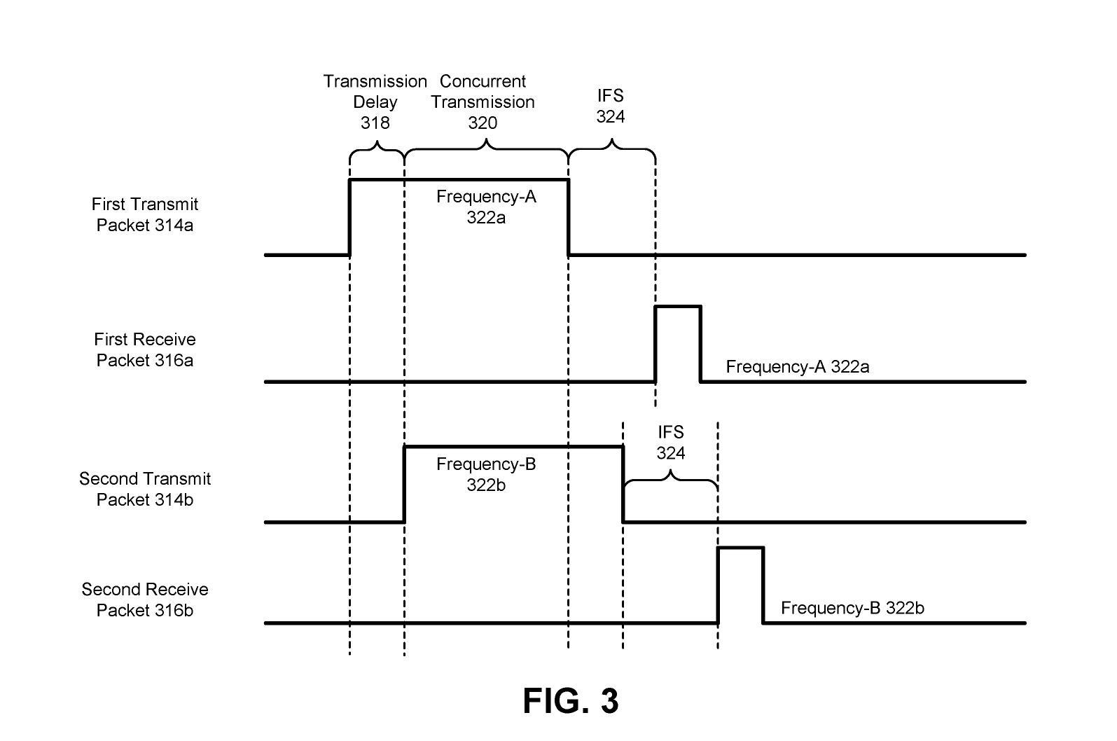

In this approach, the wireless communication device 102 may send a first transmit packet 114a for a first channel using a first transmitter 108a. The processor 106 may then delay the second transmit packet 114b for a second channel so that the second transmit packet 114b overlaps with the first transmit packet 114a but finishes before the first receive packet 116a (i.e., the ACK associated with the first transmit packet 114a) is received. This also ensures that the first receive packet 116a will be received before the second receive packet 116b is received (since there is only one demodulator 110). In this implementation, the first receive packet 116a is received entirely within the IFS between the second transmit packet 114b and the second receive packet 116b. An example of this approach is described in connection with FIG. 3.

In an implementation, the wireless communication device 102 may perform dual audio transmission. The wireless communication device 102 may use frequency hopping wireless personal area network (WPAN) transceiver hardware that has two transmitters 108 for transmit (Tx) diversity. A left channel encoded audio stream may be transmitted to a left speaker (e.g., the first remote device 104a) and a right channel encoded audio stream may be transmitted to a right speaker (e.g., the second remote device 104b) over different hopping frequency concurrently. However, the ACK/NACK receive packets 116 from each speaker are not received concurrently, allowing the use of a single demodulator 110. These ACK/NACK receive packets 116 are much shorter than audio packets in duration, and do not consume a significant amount radio link throughput. The two transmitters 108a-b may transmit left and right signals on two different frequencies so that the signals overlap (at least partially) in time. However, one of the transmitted signals may be delayed (i.e., time-shifted) so that the transmitted signals can both be acknowledged on different frequencies at different time moments using a single demodulator 110.

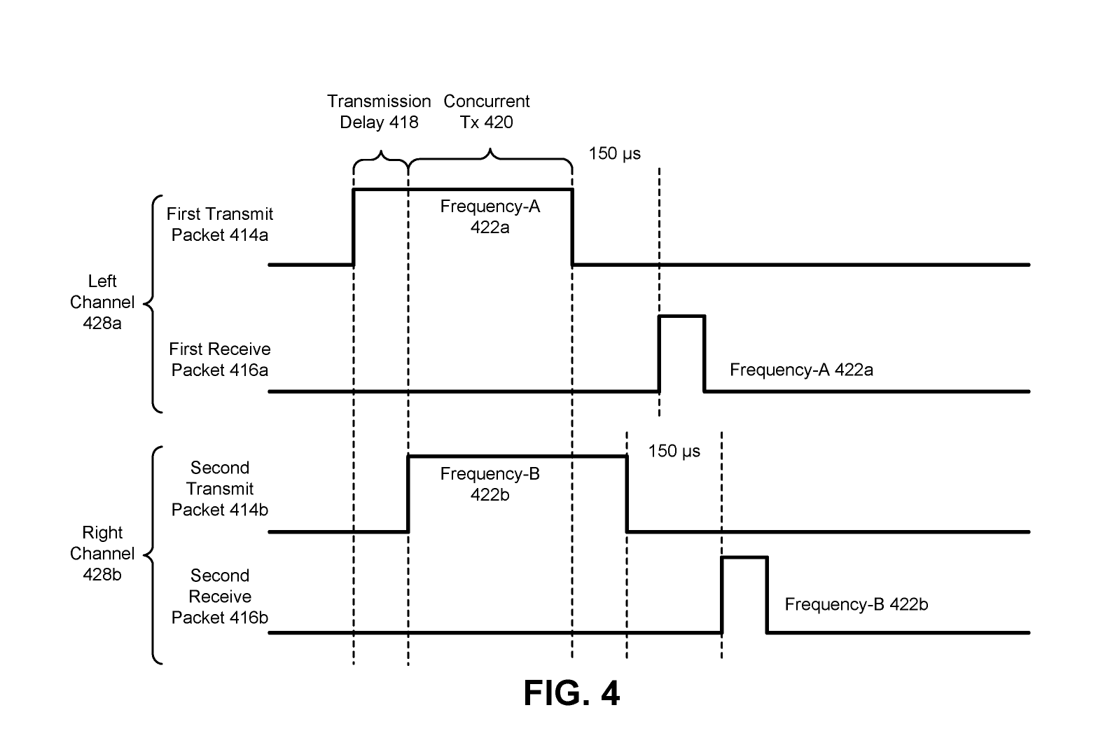

In another implementation, the wireless communication device 102 may perform dual audio transmission using Bluetooth low energy (BLE) packets, and timing. BLE slave response packets (i.e., receive packets 116) may use the same frequency as the master packets (i.e., transmit packets 114). In BLE, the IFS time interval between the transmit packet 114 and the receive packet 116 is 150 us. To receive an ACK/NACK packet from the slaves (e.g., speakers) using one demodulator 110, the receive packets 116 for left and right channels may be offset in time. At least part of the transmit duration is concurrent over the two transmitters 108a-b on two frequencies, reducing the total time the transmitters 108a-b are active. A similar approach can be applied to classic Bluetooth (e.g., Bluetooth Basic Rate/Enhanced Data Rate (BR/EDR)) or other packet radio interfaces, by using a different transmission delay (e.g., time shift) value. An example of this implementation is described in connection with FIG. 4.

It should be noted that in this approach, the transmit packets 114a-b overlap in time (this is possible since there are two transmit paths), but the receive packets 116a-b (e.g., ACK/NACKs) do not overlap (since there is only a single demodulator 110). In order to satisfy these conditions, the amount of delay for the second transmit packet 114b may be based on the IFS and the size of the first receive packet 116a (i.e., ACK corresponding to the first transmit packet 114a). The delay may be an amount of time that ensures that the first receive packet 116a is received entirely within the IFS between the second transmit packet 114b and the second receive packet 116b. For example, the delay of the second transmit packet 114b may be large enough so that the two receive packets 116 do not overlap (since there is one demodulator 110), but small enough so that the second transmit packet 114b finishes before the first receive packet 116a is received.

In another implementation, both the first receive packet 116a and the second receive packet 116b may be received on the same frequency. In this implementation, the wireless communication device 102 may transmit on different frequencies, but may receive both ACK packets on a single frequency. For example, after transmitting both transmit packets 114a-b the wireless communication device 102 may turn on one synthesizer and keep the receiver tuned to the same frequency between receive packets 116b. This implementation may allow the receive packets 116 to be closer in time using lower power. In yet another implementation, the receive packets 116 may be sent using code-division multiple access (CDMA).

In another approach, the wireless communication device 102 may send the transmit packets 114a-b at the same time (start and finish), but the second receive packet 116b may be delayed relative to the first receive packet 116a. In other words, the first and second transmit packets 114a-b are transmitted simultaneously, but the second receive packet 116b may be delayed to ensure that it does not overlap with the first receive packet 116a. In this approach, the second receive packet 116b may be sent following a different IFS than is used for the first receive packet 116a.

In an implementation, the wireless communication device 102 may configure the IFS for each remote device 104a-b. For example, the wireless communication device 102 may communicate a first IFS (to send the first receive packet 116a) to the first remote device 104a. The wireless communication device 102 may communicate a second IFS (to send the second receive packet 116b) to the second remote device 104b.

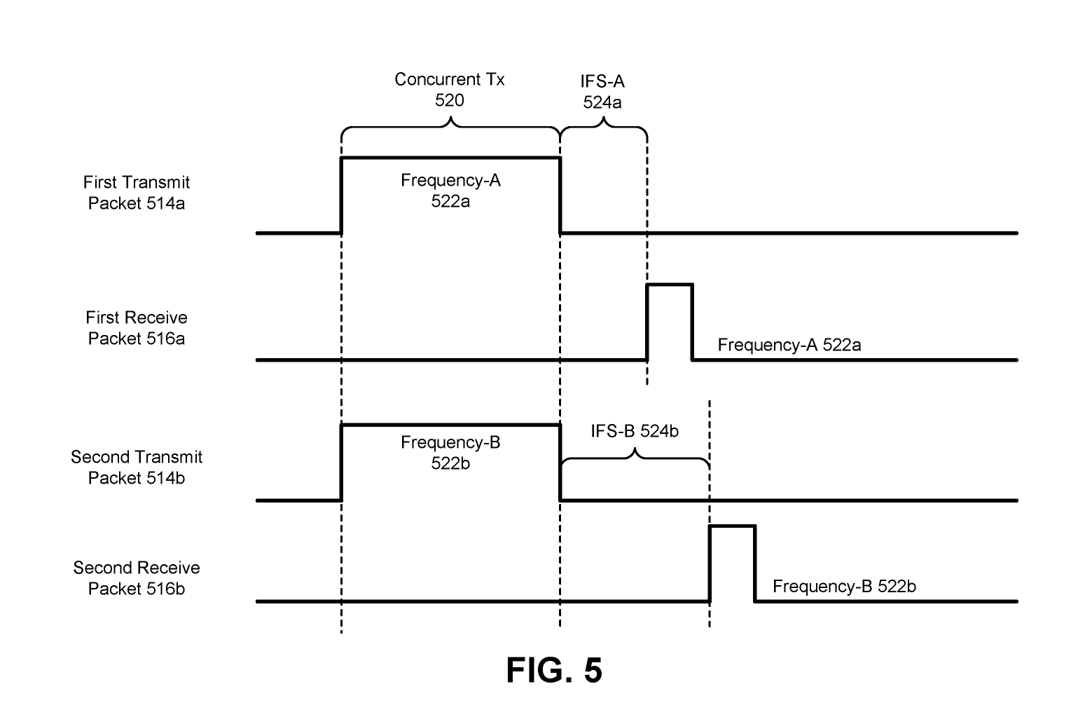

In this approach, the processor 106 may schedule transmission at the same time, but the receptions may be offset. This approach results in the same capability from the perspective of the demodulator 110, but it moves the delay into the receive packet 116. An example of this approach is described in connection with FIG. 5.

In another aspect, the wireless communication device 102 may operate as a dual transmitter with dynamic transmit diversity. For example, when only one of the remote devices 104 (e.g., audio receivers) sends a NACK (e.g., requires a retransmission) in response to a transmit packet 114, the two transmitters 108 can be used for transmit diversity (e.g., beam forming). In an implementation, the received NACK packet may be used for estimating channel state information (CSI).

The CSI may include one or more channel properties of a communication link. Examples of the CSI estimated by the wireless communication device 102 include scattering, fading, and/or power decay of the signal received from a remote device 104. In an implementation, the CSI may be estimated using a data-aided approach (e.g., training sequence or pilot sequence) or a blind estimation approach. The processor 106 may use the estimated channel state information as inputs to a beam steering algorithm for the transmitters 108.

In another implementation, both remote devices 104 may send a NACK (e.g., both remote devices 104 require a retransmission) in response to the transmit packets 114. In this case, the transmit packets 114a-b may be retransmitted concurrently, as described above. Alternatively, the transmit packets 114a-b may be retransmitted non-concurrently using beam forming, depending on the quality of the radio link.

It should be noted that these approaches may work best on wireless communication technologies that have IFS times that are large enough to ensure that the receive packets do not overlap and allow for returning. For example, WiFi only has 15 us between packet transmission and ACK. This short timeframe may not be enough for the first receive packet 116a to be received before the second receive packet 116b is received. Additionally, a short IFS may not be sufficient for the wireless communication device 102 to change from the first frequency of the first receive packet 116a to the second frequency of the second receive packet 116b. Therefore, the IFS time gap needs to be long enough compared to the receive packet length. This could be served with BT classic and BLE or their derivatives.

Also, contention-based systems (e.g., WiFi, IEEE 802.15.4, etc.) do not allow for the scheduling of different transmit packets 114 and receive packets 116 on two transceivers. The systems and methods described herein allow for scheduling the relative timing of the transmit packets 114 and receive packets 116 on the two transceivers. This may be contrasted with WiFi using two transceivers where there are different contention access schemes on each transceiver. Because of the contention access, the WiFi timing is non-deterministic. On the other hand, the described systems and methods may employ a packet-based protocol with a master-slave structure (e.g., Bluetooth) with a deterministic timing that allows for the predicable scheduling of transmissions and receptions.

The systems and methods described herein reduce the complexity of the die area (e.g., silicon) through protocol timing with two transmitters 108a-b and a single demodulator 110. By using a single demodulator 110, this results in lower costs and complexity of the wireless communication device 102. Furthermore, this reduces the size requirements of the wireless communication device 102.

In addition to saving die area by using a single demodulator 110, the described systems and methods may also reduce the total amount of time used for communicating to two slave devices. For example, because the wireless communication device 102 has two transmit paths, the wireless communication device 102 may simultaneously transmit to the two remote devices 104a-b. This has benefits for coexistence with other wireless technologies (e.g., WLAN) in terms of overall throughput. For example, higher WLAN throughput may be achieved during BT audio transmission.

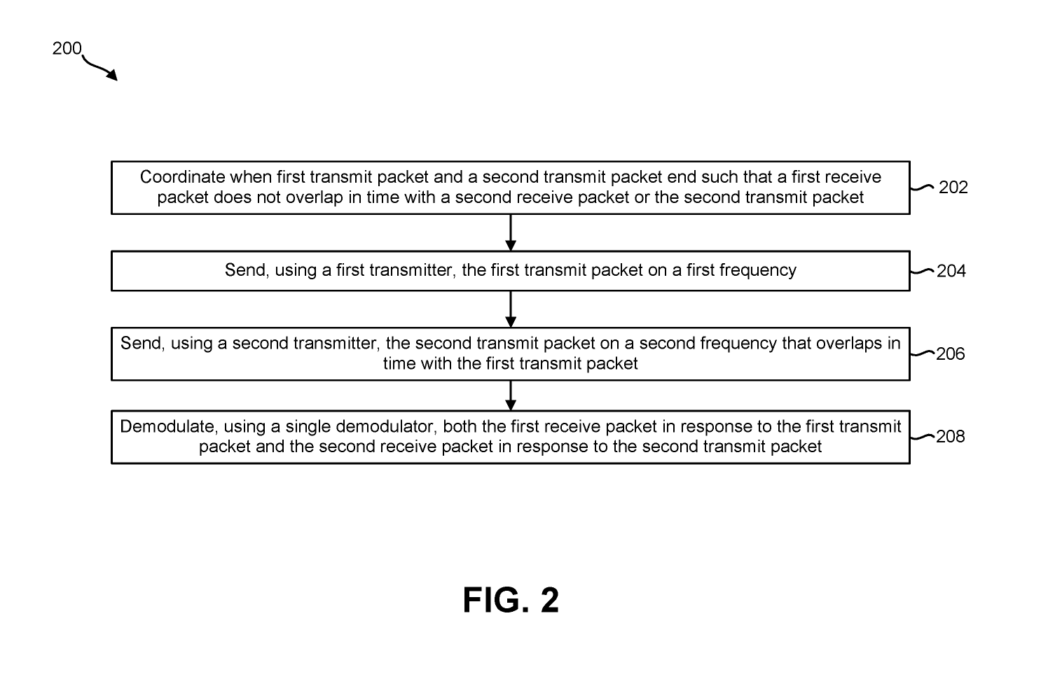

FIG. 2 is a flow diagram illustrating a configuration of a method 200 for concurrent transmission by a wireless communication device 102. The wireless communication device 102 may be connected to a first remote device 104a via a first radio link (e.g., first Bluetooth link) and a second remote device 104b via a second radio link (e.g., second Bluetooth link). The wireless communication device 102 may be configured with a first transmitter 108a, a second transmitter 108b and a single demodulator 110.

The wireless communication device 102 may coordinate 202 when a first transmit packet 114a and a second transmit packet 114b end such that a first receive packet 116a does not overlap in time with a second receive packet 116b or the second transmit packet 114b. In a first approach, the wireless communication device 102 may apply (e.g., schedule) a delay to the second transmit packet 114b to ensure that the first receive packet 116a and the second receive packet 116b do not overlap in time. The delay may be based on a size of the first receive packet 116a and an inter-frame spacing (IFS). The IFS between the first transmit packet 114a and the first receive packet 116a may be equivalent to the IFS between the second transmit packet 114b and the second receive packet 116b. This approach is described in connection with FIG. 3.

In a second approach, the first and second transmit packets 114a-b are transmitted simultaneously. In other words, transmission of the first and second transmit packets 114a-b may be scheduled to start and stop at the same time. However, the second receive packet 116b may be delayed to ensure that it does not overlap with the first receive packet 116a. This approach is described in connection with FIG. 5.

The wireless communication device 102 may send 204, using the first transmitter 108a, the first transmit packet 114a on a first frequency. The wireless communication device 102 may send 206, using the second transmitter 108b, the second transmit packet 114b on a second frequency. The second transmit packet 114b may overlap in time with the first transmit packet 114a. In the first approach, the second transmitter 108b may send 206 the second transmit packet 114b after the scheduled delay. In the second approach, the second transmitter 108b may send 206 the second transmit packet 114b concurrently with the first transmit packet 114a.

In an implementation, the first transmit packet 114a may be a left channel encoded audio stream and the second transmit packet 114b may be a right channel encoded audio stream.

The wireless communication device 102 may demodulate 208, using a single demodulator 110, both the first receive packet 116a in response to the first transmit packet 114a and the second receive packet 116b in response to the second transmit packet 114b. For example, in the first approach, the wireless communication device 102 may receive the first receive packet 116a after the IFS. The demodulator 110 may then demodulate 208 the first receive packet 116a. The wireless communication device 102 may then receive the second receive packet 116b after the scheduled delay.

In the second approach, the second receive packet 116b may be delayed (by the second remote device 104b, for instance) to ensure that it does not overlap with the first receive packet 116a. For example, the first receive packet 116a may have a first IFS and the second receive packet 116b may have a second IFS that differs from the first IFS such that the first receive packet 116a does not overlap in time with a second receive packet 116b.

In either approach, the first receive packet 116a may be received on the first frequency and the second receive packet 116b may be received on the second frequency. Alternatively, both the first receive packet 116a and the second receive packet 116b may be received on the same frequency. For example, the second remote device 104b may send the second receive packet 116b on the same frequency as the first receive packet 116a.

FIG. 3 is a timing diagram illustrating an approach for concurrent transmission by a wireless communication device 102. The wireless communication device 102 may include a first transmitter 108a, a second transmitter 108b and a demodulator 110.

The first transmitter 108a may send a first transmit packet 314a on a first frequency (Frequency-A) 322a. After a transmission delay 318, the second transmitter 108b may send a second transmit packet 314b on a second frequency (Frequency-B) 322b.

The transmission delay 318 may be a coordinated (e.g., scheduled) time offset such that a first receive packet 316a does not overlap in time with a second receive packet 316b or the second transmit packet 314b. For example, the transmission delay 318 may be calculated based on an IFS 324 between when a transmit packet 314 ends and a corresponding receive packet 316 begins. In this approach, the IFS 324 is the same for both the first transmit packet 314a and the second transmit packet 314b.

After the transmission delay 318, there is a period of concurrent transmission 320. During concurrent transmission 320, both the first transmitter 108a and the second transmitter 108b are active.

After the first transmit packet 314a ends, the IFS 324 between the first transmit packet 314a and the first receive packet 316a begins. Similarly, after the second transmit packet 314b ends, the IFS 324 between the second transmit packet 314b and the second receive packet 316b begins.

At the end of the IFS 324, the first receive packet 316a is received by the demodulator 110. It should be noted that because of the scheduled transmission delay 318, the first receive packet 316a is received during the IFS 324 of the second transmit packet 314b. Furthermore, it should be noted that the first receive packet 316a ends before the second receive packet 316b is received.

This approach has a benefit of being compliant with current Bluetooth standards. For example, Bluetooth standards specify a fixed IFS 324. By adjusting the transmission delay 318, a fixed IFS 324 may be maintained, but a single demodulator 110 may be used to receive both the first receive packet 316a and the second receive packet 316b.

In this example, the first receive packet 316a is received on Frequency-A 322a, which is the same frequency that was used to transmit the first transmit packet 314a. The second receive packet 316b is received on Frequency-B 322b, which is the same frequency that was used to transmit the second transmit packet 314b. In an alternative approach, the same frequency 322 may be used to receive both receive packets 316a-b.

FIG. 4 is a timing diagram illustrating an approach for concurrent transmission of stereo audio by a wireless communication device 102. The wireless communication device 102 may include a first transmitter 108a, a second transmitter 108b and a demodulator 110. The wireless communication device 102 may establish Bluetooth low energy (BLE) links with a first remote device 104a and a second remote device 104b.

In an implementation, the wireless communication device 102 may be a handset and the remote devices 104a-b may be audio speakers. The wireless communication device 102 may transmit a left channel 428a (also referred to as a left channel encoded audio stream) using a first transmitter 108a. The left channel 428a may be transmitted to a left speaker (e.g., the first remote device 104a) using a first hopping frequency (Frequency-A) 422a. The wireless communication device 102 may transmit a right channel 428b (also referred to as a right channel encoded audio stream) using a second transmitter 108b. The right channel 428b may be transmitted to a right speaker (e.g., the second remote device 104b) over different hopping frequency (Frequency-B) 422b.

The first transmitter 108a may send a first transmit packet 414a on the first frequency (Frequency-A) 422a. After a transmission delay 418, the second transmitter 108b may send a second transmit packet 414b on a second frequency (Frequency-B) 422b.

The transmission delay 418 may be coordinated (e.g., scheduled) such that a first receive packet 416a does not overlap in time with a second receive packet 416b or the second transmit packet 414b. For example, the transmission delay 418 may be calculated based on the BLE IFS of 150 us between when a transmit packet 414 ends and a corresponding receive packet 416 begins. In this approach, both the first transmit packet 414a and the second transmit packet 414b have the same 150 us IFS.

After the transmission delay 418, there is a period of concurrent transmission 420. During concurrent transmission 420, both the first transmitter 108a and the second transmitter 108b are active.

After the first transmit packet 414a ends, the 150 us IFS between the first transmit packet 414a and the first receive packet 416a begins. Similarly, after the second transmit packet 414b ends, the 150 us IFS between the second transmit packet 414b and the second receive packet 416b begins. However, because of the transmission delay 418, the 150 us IFS for the left and right channels 428a-b are offset.

At the end of the 150 us IFS for the left channel 428a, the first receive packet 416a is received by the demodulator 110. It should be noted that because of the scheduled transmission delay 418, the first receive packet 416a is received during the 150 us IFS of the second transmit packet 414b. Furthermore, it should be noted that the first receive packet 416a ends before the second receive packet 416b is received.

In this example, the receive packets 416 may be acknowledge (ACK) or non-acknowledge (NACK) response packets corresponding to the transmit packets 414. For example, the first response packet 416a may be an ACK or NACK sent from the first remote device 104a in response to the first transmit packet 414a. The second response packet may be an ACK or NACK sent from the second remote device 104b in response to the second transmit packet 414b.

As can be observed, the wireless communication device 102 may start transmitting the first transmit packet 414a to one earbud on one frequency 422 and then take advantage of the 150 us IFS by starting the transmission of the second transmit packet 414b a little bit delayed. The second transmit packet 414b finishes before the first receive packet 416a comes back. The first receive packet 416a also finishes reception before the second receive packet 416b comes back. From the perspective of the Bluetooth specification, communication to the left channel 428a and right channel 428b are still specification compliant, but the way they overlap is specifically designed to take advantage of being able to use a single demodulator 110.

It should be noted that this example is directed toward BLE. However, other wireless protocols (e.g., Bluetooth BR/EDR) may use a different delay and IFS values.

FIG. 5 is a timing diagram illustrating another approach for concurrent transmission by a wireless communication device 102. The wireless communication device 102 may include a first transmitter 108a, a second transmitter 108b and a demodulator 110.

The first transmitter 108a may send a first transmit packet 514a on a first frequency (Frequency-A) 522a. The second transmitter 108b may send a second transmit packet 514b on a second frequency (Frequency-B) 522b. In this approach, the first transmit packet 514a and the second transmit packet 514b are sent at the same time. This is in contrast to the approach described in connection with FIG. 3, which included a transmission delay 318. During concurrent transmission 520, both the first transmitter 108a and the second transmitter 108b are active.

After the transmit packets 514a-b end, an IFS period begins for both channels. In this approach, different IFS values may be configured for the different channels. A first IFS (IFS-A) 524a for the first receive packet 516a is scheduled to be shorter than the second IFS (IFS-B) 524b for the second receive packet 516b. IFS-B 524 may be configured to be long enough to ensure that the first receive packet 516a does not overlap in time with the second receive packet 516b. In an implementation, the wireless communication device 102 may communicate the different IFS values.

At the end of the first IFS 524a, the first receive packet 516a is received by the demodulator 110. It should be noted that the second receive packet 516b is delayed to ensure that it does not overlap with the first receive packet 516a. Furthermore, it should be noted that the first receive packet 516a ends before the second receive packet 516b is received.

In this example, the first receive packet 516a is received on Frequency-A 522a, which is the same frequency that was used to transmit the first transmit packet 514a. The second receive packet 516b is received on Frequency-B 522b, which is the same frequency that was used to transmit the second transmit packet 514b. In an alternative approach, the same frequency may be used to receive both receive packets 516a-b.

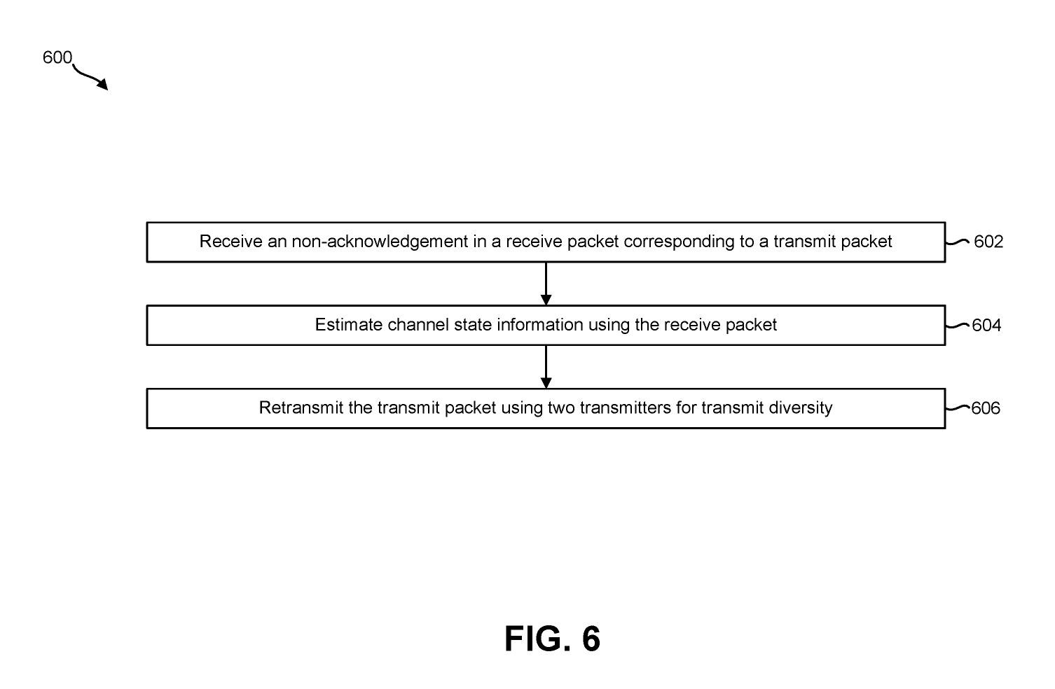

FIG. 6 is a flow diagram illustrating a configuration of a method 600 for dynamic transmit diversity by a wireless communication device 102. The wireless communication device 102 may perform concurrent transmission as described in connection with FIG. 2. For example, a first transmitter 108a may send a first transmit packet 114a on a first frequency and a second transmitter 108b may send a second transmit packet 114b on a second frequency where the second transmit packet 114b overlaps in time (at least partially) with the first transmit packet 114a.

The wireless communication device 102 may receive 602 a non-acknowledgment (NACK) in a receive packet 116 corresponding to a transmit packet 114. For example, if a first remote device 104a fails to correctly receive the first transmit packet 114a and requires a retransmission of the first transmit packet 114a, the first remote device 104a may send a NACK in the first receive packet 116a. Alternatively, the second remote device 104b may send a NACK in the second receive packet 116b if it fails to receive the second transmit packet 114b.

The wireless communication device 102 may estimate 604 channel state information using the receive packet 116. For example, the processor 106 may use the NACK response packet to estimate channel state information. The processor 106 may determine beam forming for the first transmitter 108a and the second transmitter 108b based on the channel state information.

The wireless communication device 102 may retransmit 606 the transmit packet 114 using two transmitters 108a-b for transmit diversity. For example, if a NACK response packet is received, the processor 106 may coordinate retransmission of a corresponding transmit packet 114 using both the first transmitter 108a and the second transmitter 108b. The first transmitter 108a and the second transmitter 108b may retransmit the failed transmit packet 114 using beam forming.

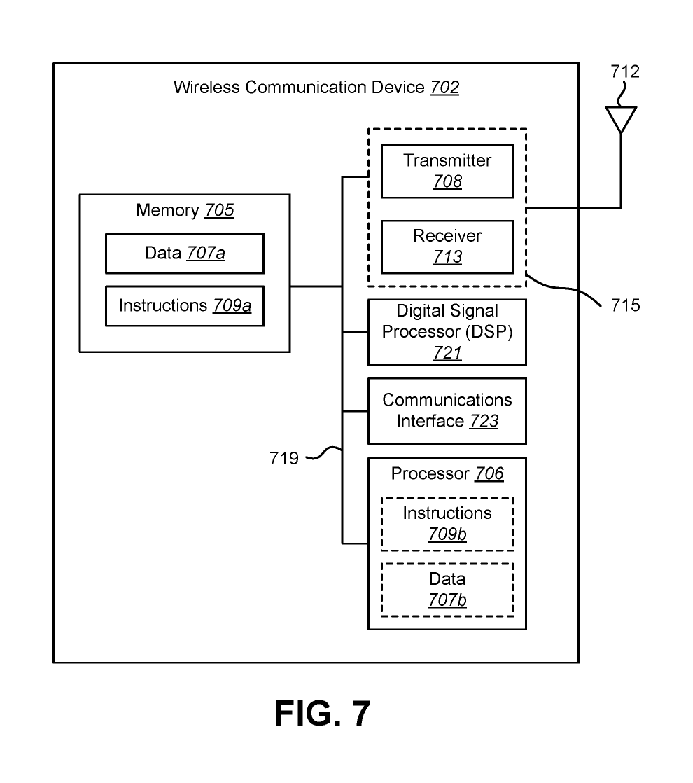

FIG. 7 illustrates certain components that may be included within a wireless communication device 702. The wireless communication device 702 may be an access terminal, a mobile station, a user equipment (UE), a laptop computer, a desktop computer, a tablet computer, a smartphone, a handset, a wireless headset, etc. For example, the wireless communication device 702 may be the wireless communication device 102 or remote devices 104 of FIG. 1.

The wireless communication device 702 includes a processor 706. The processor 706 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 706 may be referred to as a central processing unit (CPU). Although just a single processor 706 is shown in the wireless communication device 702 of FIG. 7, in an alternative configuration, a combination of processors (e.g., an ARM and DSP) could be used.

The wireless communication device 702 also includes memory 705 in electronic communication with the processor (i.e., the processor can read information from and/or write information to the memory). The memory 705 may be any electronic component capable of storing electronic information. The memory 705 may be configured as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 707a and instructions 709a may be stored in the memory 705. The instructions may include one or more programs, routines, sub-routines, functions, procedures, code, etc. The instructions may include a single computer-readable statement or many computer-readable statements. The instructions 709a may be executable by the processor 706 to implement the methods disclosed herein. Executing the instructions 709a may involve the use of the data 707a that is stored in the memory 705. When the processor 706 executes the instructions 709, various portions of the instructions 709b may be loaded onto the processor 706, and various pieces of data 707b may be loaded onto the processor 706.

The wireless communication device 702 may also include a transmitter 708 and a receiver 713 to allow transmission and reception of signals to and from the wireless communication device 702 via one or more antennas 712. The transmitter 708 and receiver 713 may be collectively referred to as a transceiver 715. The wireless communication device 702 may also include (not shown) multiple transmitters, multiple antennas, multiple receivers and/or multiple transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. A wireless communication device for concurrent transmission, comprising:
a first transmitter that sends a first transmit packet on a first frequency;
a second transmitter that sends a second transmit packet on a second frequency that overlaps in time with the first transmit packet;
a processor that coordinates when the first and second transmit packets end such that a first receive packet does not overlap in time with a second receive packet or the second transmit packet; and
a demodulator that demodulates both the first receive packet in response to the first transmit packet and the second receive packet in response to the second transmit packet.

2. The wireless communication device of claim 1, wherein the processor applies a delay to the second transmit packet to ensure that the first receive packet and the second receive packet do not overlap in time.

3. The wireless communication device of claim 2, wherein the delay is based on a size of the first receive packet and an inter-frame spacing.

4. The wireless communication device of claim 3, wherein the inter-frame spacing between the first transmit packet and the first receive packet is equivalent to the inter-frame spacing between the second transmit packet and the second receive packet.

5. The wireless communication device of claim 1, wherein the first and second transmit packets are transmitted simultaneously, but the second receive packet is delayed to ensure that it does not overlap with the first receive packet.

6. The wireless communication device of claim 1, wherein the first receive packet is received on the first frequency and the second receive packet is received on the second frequency.

7. The wireless communication device of claim 1, wherein both the first receive packet and the second receive packet are received on the same frequency.

8. The wireless communication device of claim 1, wherein the first transmit packet comprises a left channel encoded audio stream and the second transmit packet comprises a right channel encoded audio stream.

9. The wireless communication device of claim 1, wherein the first response packet comprises an acknowledge (ACK) or non-acknowledge (NACK) response packet corresponding to the first transmit packet and the second response packet comprises an ACK or NACK response packet corresponding to the second transmit packet.

10. The wireless communication device of claim 9, wherein if a NACK response packet is received, the processor coordinates a retransmission of a corresponding transmit packet using both the first transmitter and the second transmitter.

11. The wireless communication device of claim 10, wherein the processor uses the NACK response packet to estimate channel state information and to determine beam forming for the first transmitter and the second transmitter based on the channel state information.

12. A method for concurrent transmission, comprising:
sending, by a first transmitter, a first transmit packet on a first frequency;
sending, by a second transmitter, a second transmit packet on a second frequency that overlaps in time with the first transmit packet;
coordinating, by a processor, when the first and second transmit packets end such that a first receive packet does not overlap in time with a second receive packet or the second transmit packet; and
demodulating, by a demodulator, both the first receive packet in response to the first transmit packet and the second receive packet in response to the second transmit packet.

13. The method of claim 12, further comprising applying a delay to the second transmit packet to ensure that the first receive packet and the second receive packet do not overlap in time.

14. The method of claim 13, wherein the delay is based on a size of the first receive packet and an inter-frame spacing.

15. The method of claim 12, wherein the first and second transmit packets are transmitted simultaneously, but the second receive packet is delayed to ensure that it does not overlap with the first receive packet.

16. The method of claim 12, wherein the first receive packet is received on the first frequency and the second receive packet is received on the second frequency.

17. The method of claim 12, wherein both the first receive packet and the second receive packet are received on the same frequency.

18. The method of claim 12, wherein the first transmit packet comprises a left channel encoded audio stream and the second transmit packet comprises a right channel encoded audio stream.

19. A non-transitory tangible computer readable medium for concurrent transmission, the computer readable medium storing computer executable code, comprising:
code for causing a wireless communication device to send, by a first transmitter, a first transmit packet on a first frequency;
code for causing the wireless communication device to send, by a second transmitter, a second transmit packet on a second frequency that overlaps in time with the first transmit packet;
code for causing the wireless communication device to coordinate, by a processor, when the first and second transmit packets end such that a first receive packet does not overlap in time with a second receive packet or the second transmit packet; and
code for causing the wireless communication device to demodulate, by a demodulator, both the first receive packet in response to the first transmit packet and the second receive packet in response to the second transmit packet.

20. The computer readable medium of claim 19, further comprising code for causing the wireless communication device to apply a delay to the second transmit packet to ensure that the first receive packet and the second receive packet do not overlap in time.

21. The computer readable medium of claim 20, wherein the delay is based on a size of the first receive packet and an inter-frame spacing.

22. The computer readable medium of claim 19, wherein the first and second transmit packets are transmitted simultaneously, but the second receive packet is delayed to ensure that it does not overlap with the first receive packet.

23. The computer readable medium of claim 19, wherein the first receive packet is received on the first frequency and the second receive packet is received on the second frequency.

24. The computer readable medium of claim 19, wherein both the first receive packet and the second receive packet are received on the same frequency.

25. An apparatus for concurrent transmission, comprising:
means for sending a first transmit packet on a first frequency;
means for sending a second transmit packet on a second frequency that overlaps in time with the first transmit packet;
means for coordinating when the first and second transmit packets end such that a first receive packet does not overlap in time with a second receive packet or the second transmit packet; and
means for demodulating both the first receive packet in response to the first transmit packet and the second receive packet in response to the second transmit packet.

26. The apparatus of claim 25, further comprising means for applying a delay to the second transmit packet to ensure that the first receive packet and the second receive packet do not overlap in time.

27. The apparatus of claim 26, wherein the delay is based on a size of the first receive packet and an inter-frame spacing.

28. The apparatus of claim 25, wherein the first and second transmit packets are transmitted simultaneously, but the second receive packet is delayed to ensure that it does not overlap with the first receive packet.

29. The apparatus of claim 25, wherein the first receive packet is received on the first frequency and the second receive packet is received on the second frequency.

30. The apparatus of claim 25, wherein both the first receive packet and the second receive packet are received on the same frequency.
